(19) United States
(12) Patent Application Publication
(10) Pub. No.: US 2009/0015716 A1
(43) Pub. Date: Jan. 15, 2009

(54) Method and System For Rendering Content From Two Programs Simultaneously

(75) Inventor: Peter M. Doedens, Cumming, GA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/776,071

(22) Filed: Jul. 11, 2007

(51) Int. Cl. H04N 5/445

(52) U.S. Cl. 348/564; 348/E05.099

(57) ABSTRACT

Methods, systems and computer readable media are disclosed that combine media content. A user is allowed to select one source for primary media content and a second source for secondary media content and combine them into one combined media content.

### FIELD OF THE INVENTION

The present invention relates to receiving at least two pieces of media content, and merging those pieces of media content for rendering on a single device.

### BACKGROUND OF THE INVENTION

There are many instances when people want to receive content from two sources at the same time. As an example, people may want to watch one sports program on one channel and periodically check in on another sports program on another channel. To achieve this result, picture-in-picture (PIP) technology was developed. In PIP, two tuners are used to tune to both programs simultaneously. One program is displayed in full on the screen and the other is displayed on a reduced scale superimposed over a small portion of the main program.

While PIP does allow for a person to receive content from two sources at the same time, it does have some disadvantages. At least one program will be displayed on a reduced scale. If the user wants to view the information being scrolled across the bottom of the screen in the smaller window, it will be difficult or impossible to read the text if the display device or window is small. Thus, if a parent wants to put a child's program as the main display, yet read sports scores, stock reports, weather updates or breaking news as scrolling text, a PIP solution may yield scrolling text that is too small to read. The user would then have to switch channels and thereby deprive the child of watching his program in the larger window in order to read the scrolling text.

### BRIEF DESCRIPTION OF THE FIGURES

FIG. 1 is a block diagram of a set-top box;

FIG. 2 is a block diagram of a content processor;

FIG. 3 is a screen shot of a user interface to select portions of content;

FIG. 4 is a diagram of elementary data streams;

FIG. 5 is a flowchart for a process of selecting and mixing content from two sources;

FIG. 6 is a screen-shot of an illustrative image that is formed using components from two different sources; and

FIG. 7 is a block diagram of another content processor.

### DETAILED DESCRIPTION

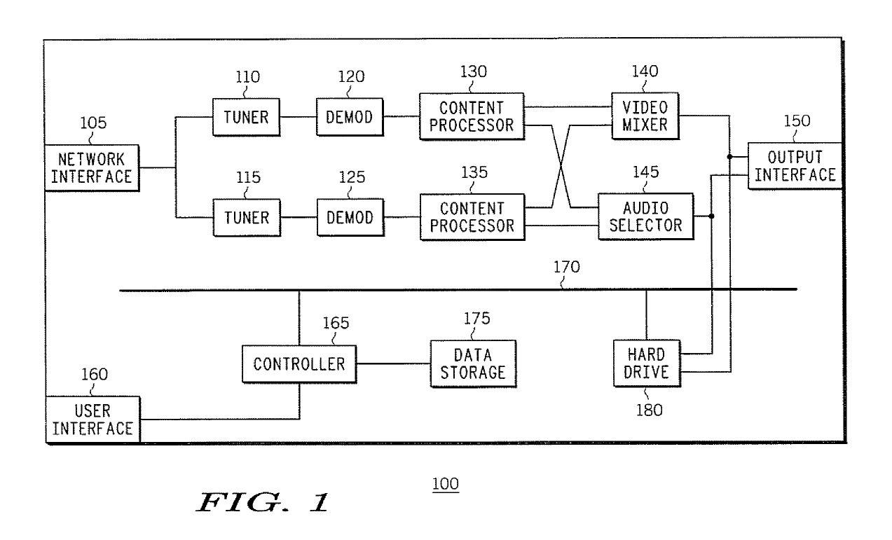

FIG. 1 shows an illustrative block diagram of a set-top box 100. It should be understood that the circuitry of set-top box 100 may also be integrated into a television or other device and therefore not be a separate device as shown. Set-top box 100 receives and processes media content. Typically this media content is broadcast to set-top box 100 and to other set-top boxes and televisions (not shown). Examples of the media content include but are not limited to video, audio, text messages, alphanumeric data, images and graphics. The media content can be divided into two categories; primary media content and secondary media content. The primary media content is audio/video data or information that is rendered in a superior fashion to the secondary media content. In one implementation, the primary media content is displayed or rendered on a majority of the screen of the television or monitor or played over the speakers. As an example, if the media content is a broadcast news program, the primary media content includes the images and voice of the newscaster speaking.

The secondary media content is audio and/or video data or information that is rendered along with the primary media content but in an inferior or subordinate fashion. The secondary media content is displayed or rendered on a minority portion of the screen of the television or monitor. If the media content is the same broadcast news program described above, the secondary media content includes the scrolling text displayed on the bottom portion of the screen. Other examples of secondary media content may include, but are not limited to, traffic updates, weather forecasts, sports updates, program schedules, news, and community updates. The secondary media content can be in the form of a text message, alphanumeric data, images, graphics and the like. In one implementation, this secondary media content is provided through a mechanism to display information as a scrolling text or a ticker on the display screen of the television set.

FIG. 1 shows a block diagram of an illustrative set-top box 100. Set-top box 100 receives multimedia content at network interface 105. Network interface 105 is typically hardware and software that is designed to receive multimedia content from a particular provider such as a cable television or satellite television provider. One function of network interface 105 is to split the received signals. The signals are then forwarded to tuners 110 and 115. Tuners 110 and 115 typically select one program, or a group of programs, transmitted on a particular frequency. As an example, tuner 110 tunes to one source of content that includes the primary multimedia content and tuner 115 tunes to another source of content that includes the secondary multimedia content.

The outputs from tuners 110 and 115 are input into demodulators 120 and 125. Typically each piece of content transmitted over a given frequency is modulated using quadrature amplitude modulation (QAM). In order to render the content, it must be demodulated. In one implementation, demodulators 120 and 125 are quadrature amplitude demodulators (QAM). The outputs of demodulators 120 and 125 are input into content processor 130 and 135, respectively. Content processors 130 and 135 generally decrypt, decode and select a particular piece of content for rendering as will be described later.

The outputs from content processors 130 and 135 are input into video mixer 140 and audio selector 145. Video mixer 140 combines two video images into one. As an example, video mixer 140 receives the primary multimedia content from content processor 130 and the secondary multimedia content from content processor 135 and combines them into a single piece of content, image or stream of images.

Audio selector 145 selects one source of audio signals from the two provided to it by content processors 130 and 135. The outputs from video mixer 140 and audio selector 145 are output to output interface 150. Output interface 150 forwards the signals to a rendering device such as a television or monitor (not shown).

A user inputs commands using another device such as a remote control or keyboard (not shown) into user interface 160. These commands typically include commands for selecting which piece of content to consume as well as to select two pieces of content to consume in a primary and secondary fashion. User interface 160 forwards the received signals to controller 165. Controller 165 processes user input commands and issues commands onto bus 170. Bus 170 carries data and instructions between the blocks 105-150 and controller 165. The connections between bus 170 and blocks 105-150 are omitted for the sake of clarity. Data storage 175 is coupled to controller 165 and stores applications and an operating system used by controller 165 to control set-top box 100.

Hard drive 180 is coupled to the outputs of video mixer 140 and audio selector 145. Hard drive 180 stores selected audio and video content output by video mixer 140 and audio selector 145. Set-top box 100 is sometimes called a digital video recorder (DVR) or personal video recorder (PVR) when it includes a hard drive like 180 for storing content. In one implementation, hard drive 180 has encryption/decryption circuitry associated with it (not shown) so that content is not stored in the clear. It should also be noted that hard drive 180 could be coupled to the outputs of demodulators 120 and 125 or content processors 130 and 135 in alternative implementations. However, in the configuration shown in FIG. 1, hard drive 180 allows the recording of the combined signals. Thus, a user could rewind the content to re-watch scrolling text he missed or even perform a live-pause operation where the primary video and secondary video are paused while the currently broadcasted material is stored on hard-drive 180 for later consumption. Finally, in an alternative implementation, hard drive 180 could be implemented using semiconductor memory such as RAM or EPROM.

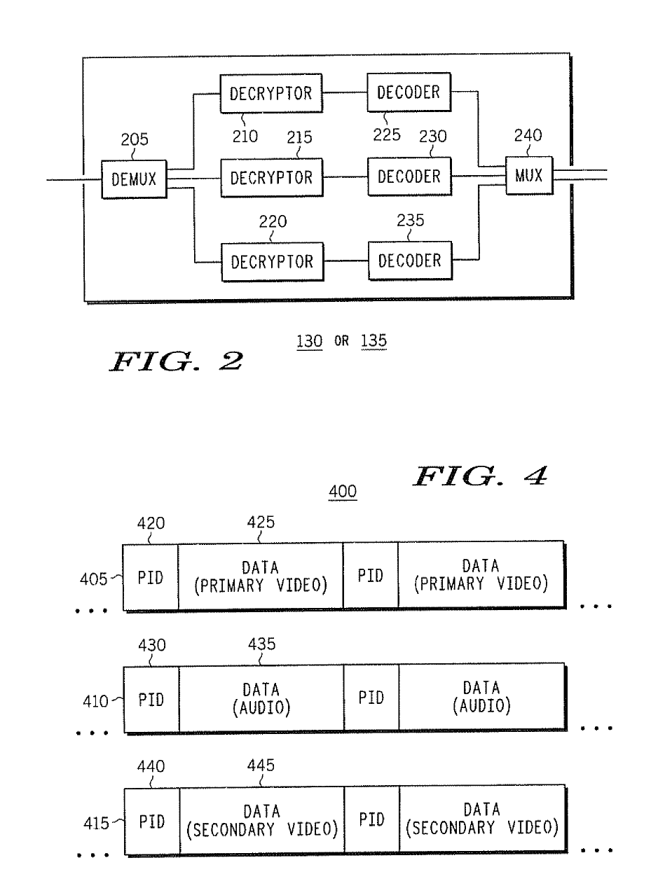

FIG. 2 is a block diagram of content processor 130 or 135. Content processor 130 or 135 includes a demultiplexer 205. Demultiplexer 205 selects one portion of the received media content. As will be described later, demultiplexer 205 selects between different programs within a stream as well as different portions of multimedia content from a single program. Decryptors 210, 215 and 220 use keys to decrypt the multimedia content output from demultiplexer 205. Once the portions of the content are decrypted, the portions are decoded by decoders 225, 230 and 235. As an example, decoders 225, 230 and 235 may be MPEG-2 or MPEG-4 decoders. The output from decoders 225, 230 and 235 are input into multiplexer 240 that selects which portion of the content is output to video mixer 140 and audio selector 145.

As an example, content processor 130 or 135 operates as follows. Multimedia content that includes primary video, secondary video and audio content is input into demultiplexer 205. Demultiplexer 205 divides the content into its constituent three parts. Thus, the primary video is decrypted by decryptor 210 and decoded by decoder 225; the secondary video is decrypted by decryptor 215 and decoded by decoder 230 and the audio content is decrypted by decryptor 220 and decoder 235. Multiplexer 240 selects one, two or three of those constituent parts and outputs them to video mixer 140 and audio selector 145. Thus, content processor 130 could output the primary video and audio from a first program while content processor 135 outputs the secondary video from a second program. Video mixer 140 then combines the primary video from the first program with the secondary video from the second program into one stream of images.

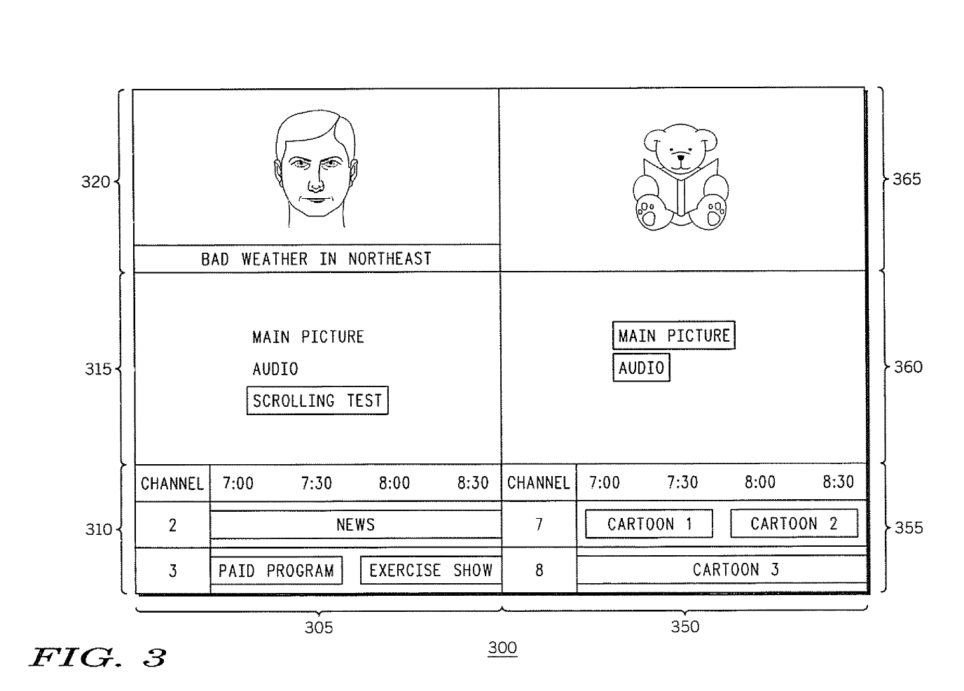

FIG. 3 is an illustrative screen shot 300 for providing information and receiving user input on how to receive multiple pieces of content substantially simultaneously. Screen 300 is divided into two parts, 305 and 350. Each part is used to select a source of primary multimedia content and a secondary source of multimedia content. Sections 310 and 355 include grids for providing electronic programming guide (EPG) information. They include times programs run, channels on which they are provided and titles and other metadata describing each program.

Sections 315 and 360 provide menus the user uses to select how multiple pieces of multimedia content are provided. For example, section 315 shows the user has selected the scrolling text from the program selected in the EPG 310 by moving highlight boxes. Similarly, the user has also selected the main picture and audio in section 360 from the program selected in grid 355. The user can select and de-select whatever portion of content is available from each selected program. Sections 320 and 365 are windows that show the video of the programs selected by the user in EPG sections 310 and 355. Based on the selections shown in FIG. 3, the user has selected to output the primary video and audio from a cartoon and the scrolling text from a news station contemporaneously.

FIG. 4 shows a group of exemplary elementary streams 400. Group 400 includes three elementary streams 405, 410 and 415. In one implementation, elementary streams 405, 410 and 415 are all from the same piece of content. In an alternative implementations, elementary streams 405 and 410 are from one piece of content and elementary stream 415 is from another piece of content. It should be noted that other streams are possible that include content from more than one program. The elementary stream contains many packets, three of which are shown 405, 410 and 415. Each packet includes a header 420, 430 and 440 and payload data 425, 435 and 445, respectively. Each header contains a packet identifier (PID). The PID identifies that packet as belonging to that program. Since 400 is an elementary stream, every PID in it will relate to that program.

As can be seen in FIG. 4, the payloads in each packet may be of a different type. For example, payload 425 is data that generates the primary video. Referring to section 320 of FIG. 3, the primary video is that video associated with the newscaster's head and neck and surrounding regions. Payload 435 includes the audio data of the program. Payload 445 contains data for the secondary video such as scrolling text or some other graphical overlay. In section 320, this is the scrolling text. It should be understood that other types of payload data may be available in an elementary stream.

There are a plurality of ways to distinguish between different payload packets in an elementary stream. One way is to have a set of bits as part of the PID. Typically these bits will be a prefix or suffix set of bits. As an example, PID 101111 goes with program 1011 as does PID 101101 because both start with 1011. The suffixes 11 and 01 might identify different types of data such as primary video, secondary video or audio.

Another way to identify different types of payload data includes embedding metadata in the payload data itself or in the EPG data. Thus, bits can be inserted into the payload data so that it can be identified as primary video, secondary video or audio. Either way, demultiplexer 205 and multiplexer 240 use this data, either in the PID or in the payload, to separate and combine different portions of content.

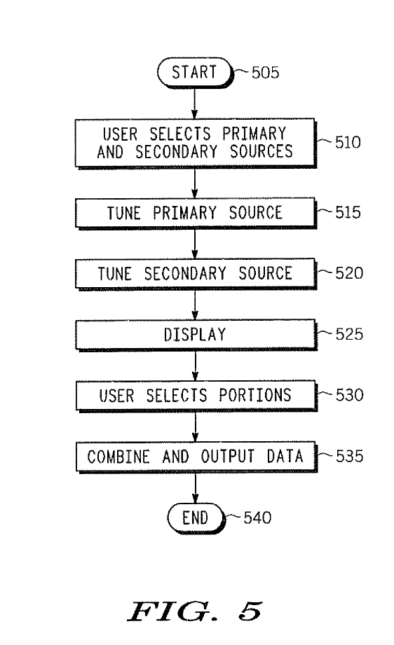

FIG. 5 is a flowchart for a method 500 for displaying two or more portions of content simultaneously. The method begins at step 505. At step 510, the user selects the two or more sources of content for rendering. As an example, a user may use a remote control to input signals to controller 165 via user interface 160. Controller 165 will execute an application stored in memory 175 to generate the screen 300 shown in FIG. 3. As previously described, the user will scroll through the EPGs displayed in sections 310 and 355 and select at least two sources of content.

At steps 515 and 520, tuners 110 and 115 respond to the user's input and tune to the selected frequencies and demodulators 120 and 125 demodulate their respective signals. Content processors 130 and 135 will also decrypt and decode the selected content. The chosen programs are then displayed in windows 320 and 365 via video mixer 140, audio selector 145 and output interface 150 at step 525. Once each source is selected, sections 315 and 360 are filled with the choices available to the user at step 525. For example, the EPG data may include metadata that indicates the types of content in each program. Some programs do not include secondary media, such as scrolling text, and therefore this option would not be presented to the user in section 315 or 360 because the data in the EPG would indicate that that program does not have secondary media content. In another implementation, content processors can read the PIDS or data in the payloads and inform controller 165 of the existence or absence of certain portions of data. Controller 165 would then run an application and generate the appropriate choices for the user as displayed in sections 315 and 360.

At step 530, the user selects which portions of content from the two programs he wishes to consume. That is, controller 165 receives the user's input via user interface 160 to control sections 315 and 360 so that the user can move the box around, and thereby select, portions of desired content from the two programs.

At step 535, controller 165 instructs content processors 130 and 135, video mixer 140 and audio selector 145 to combine the desired portions of content, mix the video together and output the mixed content via output interface 150. The process then ends at step 540.

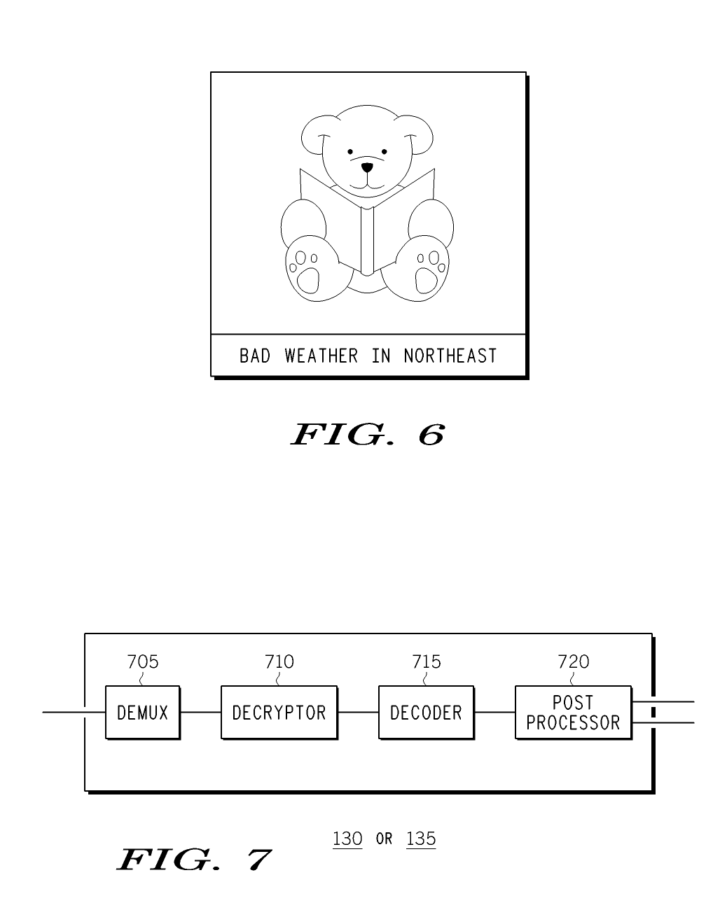

FIG. 6 is a screen-shot of the combined image. The user has selected a child's program to be the main display image and the scrolling text from a new channel. It should be noted that in some implementations, the user has the options, via a menu and a remote control, to move the scrolling text to other portions of the screen (e.g., across the top) or to rescale the secondary video to make it larger or smaller.

The process shown in FIG. 5 may be implemented in a general, multi-purpose or single purpose processor. Such a processor will execute instructions, either at the assembly, compiled or machine-level, to perform that process. Those instructions can be written by one of ordinary skill in the art following the above description and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

In the foregoing specification, the invention and its benefits and advantages have been described with reference to specific illustrative examples. However, one with ordinary skill in the art would appreciate that various modifications and changes can be made without departing from the scope of the present invention, as set forth in the claims below.

For example, FIG. 7 shows an alternative implementation for a content processor 130 or 135. In the implementation shown in FIG. 7, demultiplexer 705 outputs into one decryptor 710 which in turn outputs into one decoder 715 The output of decoder 715 is then input into a post processor 720. In this implementation, demultiplexer 205 only outputs the desired packets to the decryptor 710 and decoder 715. Unselected packets are discarded by demultiplexer 705. It should be noted that in such an implementation, multiplexer 240 shown in FIG. 2 is omitted. In yet another implementation, one could add additional decryptors and decoders beyond the 3 sets shown in FIG. 2.

FIG. 7 also differs from FIG. 2 in that FIG. 7 adds a post processor 720 after decoder 715. Post processor may perform any of a number of functions such as re-scaling, creating translucent overlays or repositioning.

When post processor 720 rescales content, it can make it larger or smaller. This is particularly useful for the secondary content when it is scrolling text. In this example, the user inputs commands to controller 165 via user interface 160. Controller 165 instructs post processor 720 to make the secondary text larger or smaller. Similarly, post processor 720 may also change the orientation of a piece of content. For example, if the secondary content is scrolling text that appears along the bottom of the screen, the user may input a selection to get the scrolling text to scroll across the top of the screen.

When post processor 720 creates overlays, it changes the contrast and/or brightness of the chosen content. Video mixer 140 is similarly controlled by controller 165 to display both sets of pixel data contemporaneously. The net effect is the secondary content, if selected, appears as a translucent overlay over the primary content.

In yet another implementation, FIG. 1 can be modified to have only one content processor instead of two. The data from the two demodulators is processed in this one content processor on a time basis. Since the content processor is being shared, buffers may be needed to keep the timing of data intact.

In yet another implementation one of the decoders in FIG. 2. could be eliminated. This would happen when the secondary video is text data like closed-captioning or scrolling text. In this case, the data is transmitted plain and not encoded. There would therefore be no need for a decoder for text data and thus it could be omitted.

In another illustrative example, the signals of the secondary media content can also be received from another delivery service. For example, the signals of the secondary media content can be received from the Internet via a cable modem, DOCSIS or DSL modem.

While FIG. 6 only shows the combination of two programs, it should be understood that any number of services may be combined. For example, FIG. 1 could be modified to include a third tuner, third demodulator and third content processor. In such an implementation, the user could receive two secondary videos and display them along with the primary video. Thus, a user could receive scrolling stock quotes along the bottom of the screen while receiving weather updates across the top of the screen.

Finally, the method steps shown in FIG. 5 may be performed in alternative orders. For example, after the user selects which pieces of content to combine, the system may thereafter tune to those selected pieces of content.

What is claimed is:

1. A device for combining media content comprising:
a network interface configured to receive first media content and second media content;
a first tuner that selects a first frequency that carries the first media content;
a second tuner that selects a second frequency that carries the second media content;
a first content processor that selects and outputs a first portion of the first media content and does not output a second portion of the first media content; and
a mixer that mixes the first portion of the first media content with the second media content to form combined media content.

2. The device of claim 1 further comprising:
a second content processor that selects and outputs a first portion of the second media content and does not output a second portion of the second media content.

3. The device of claim 2 wherein the first content processor outputs a third portion of the first media content and the second content processor outputs a third portion of the second media content.

4. The device of claim 3 further comprising:
a selector circuit that selects between and outputs either the third portion of the first media content or the third portion of the second media content.

5. The device of claim 1 wherein the first content processor comprises:
a demultiplexer that receives the first media content;
a first decryptor that decrypts the first portion of the first media content; and
a first decoder that decodes the first portion of the first media content.

6. The device of claim 5 wherein the first content processor further comprises:
a second decryptor that decrypts the second portion of the first media content;
a second decryptor that decrypts the second portion of the first media content; and
a multiplexer that outputs the first portion of the first media content and does not output the second portion of the second media content.

7. The device of claim 5 wherein the first content processor further comprises:
a scalar that scales the first portion of the first media content.

8. The device of claim 5 wherein the first content processor further comprises:
a processor that reorients a location of the first portion of the first media content on a screen.

9. The device of claim 1 further comprising:
a memory that stores the combined media content output by the mixer.

10. A method for combining media content comprising:
tuning to a first frequency that carries primary media content;
tuning to a second frequency that carries secondary media content;
receiving a first user selection that selects a first portion of the primary media content; and
receiving a second user selection that selects a first portion of the secondary media content and rejects a second portion of the secondary media content.

11. The method of claim 10 further comprising:
generating combined media content comprising the first portion of the primary media content and the first portion of the secondary media content.

12. The method of claim 10 further comprising:
scaling the first portion of the secondary media content.

13. The method of claim 10 further comprising:
reorienting the first portion of the secondary media content.

14. The method of claim 10 further comprising:
processing the first portion of the secondary media content so that it becomes a translucent overlay over the first portion of the primary media content.

15. The method of claim 11 further comprising:
storing the combined media content.

16. A computer readable medium that stores instructions that when read by one or more processors performs a method for combining media content comprising:
tuning to a first frequency that carries primary media content;
tuning to a second frequency that carries secondary media content;
receiving a first user selection that selects a first portion of the primary media content; and
receiving a second user selection that selects a first portion of the secondary media content and rejects a second portion of the secondary media content.

17. The computer readable medium of claim 16 further comprising instructions for:
generating combined media content comprising the first portion of the primary media content and the first portion of the secondary media content.

18. The computer readable medium of claim 16 further comprising instructions for:
scaling the first portion of the secondary media content.

19. The computer readable medium of claim 16 further comprising instructions for:
reorienting the first portion of the secondary media content.

20. The computer readable medium of claim 17 further comprising instructions for:
storing the combined media content.
